(19) United States
(12) Patent Application Publication
(10) Pub. No.: US 2009/0307683 A1
(43) Pub. Date: Dec. 10, 2009

(54) Network-Based Update of Application Programs

(76) Inventor: Sam Gharabally, San Francisco, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/171,186

(22) Filed: Jul. 10, 2008

Related U.S. Application Data
(60) Provisional application No. 61/059,791, filed on Jun. 8, 2008.

(51) Int. Cl. G06F 9/44

(52) U.S. Cl. 717/173

(57) ABSTRACT

Improved approaches for submission, management and/or distribution of updates to digital products, such as application programs (software programs), with respect to an online product distribution site are disclosed. Updates to numerous digital products can be centrally managed in a uniform and computer-assisted manner so that updates can be efficiently distributed to appropriate users.

### CROSS-REFERENCE TO OTHER APPLICATIONS

This application claims priority to U.S. Provisional Patent Application No. 61/059,791, filed Jun. 8, 2008, entitled “NETWORK-BASED UPGRADE OF APPLICATION PROGRAMS”, which is herein incorporated herein by reference.

This application references and/or incorporates: (i) U.S. Provisional Patent Application No. 61/050,478, filed May 5, 2008, entitled “ELECTRONIC SUBMISSION AND MANAGEMENT OF DIGITAL PRODUCTS FOR NETWORK-BASED DISTRIBUTION”, which is hereby incorporated herein by reference; (ii) U.S. Provisional Patent Application No. 61/059,792, filed Jun. 8, 2008, entitled “ELECTRONIC SUBMISSION OF APPLICATION PROGRAMS FOR NETWORK-BASED DISTRIBUTION”, which is hereby incorporated herein by reference; (iii) U.S. Provisional Patent Application No. 61/059,790, filed Jun. 8, 2008, entitled “NETWORK-BASED DISTRIBUTION OF APPLICATION PRODUCTS”, which is hereby incorporated herein by reference; and (iv) U.S. Patent Application No. ______[Att.Dkt.No. 101-P561], filed Jul. 10, 2008, entitled “TECHNIQUES FOR ACQUIRING UPDATES FOR APPLICATION PROGRAMS”, which is herein incorporated herein by reference.

### BACKGROUND OF THE INVENTION

1. Field of the Invention

The present invention relates to updates for application programs and, more particularly, to acquisition of updates for application programs.

2. Description of the Related Art

Software programs are commonly available for purchase (or license) at brick-and-mortar stores as well as online stores. A software program is often purchased as a compact disc (CD) containing the software program. Alternatively, purchasers can purchase and download a software program from an online retailer or software provider's website. After a purchaser receives the software program, the software provider might release another version of the software program. Conventionally, new releases can require the purchaser to purchase the new version if they wish to upgrade to the new version. To obtain an upgrade, a purchaser visits a physical or online store of the retailer or software provider (or their agent) to purchase and acquire the new version. In some cases, the new version can be referred to as an update because it primarily contains “fixes” or new minor features for the earlier version of the software program such updates can be made available to purchasers of the earlier version often for little or no additional cost.

Unfortunately, however, purchasers of software programs often have numerous software programs on their computing devices. As a result, it is not practical for software purchasers to periodically check with various software developers and/or retailers for updated versions of the numerous software programs. While software providers might advertise or provide notification (e.g., email notification) of an update, there is no satisfactory centralized approach for updating applications. In some cases, for specialized software, Internet-based updates can be automatically provided. For example, a software application (such as an anti-virus program) can automatically check a remote server of a software provider to obtain updates, typically new security updates.

Accordingly, there is a need for improved approaches to distribute or acquire updates to software programs.

### SUMMARY OF THE INVENTION

The invention relates to submission, management and/or distribution of updates to digital products, such as application programs (software programs), with respect to an online product distribution site. Updates to numerous digital products can be centrally managed in a uniform and computer-assisted manner so that updates can be efficiently distributed to appropriate users.

In one embodiment, an online product distribution system can alert users of updated applications that are available to the users. Users can then elect to acquire one, some or all of the updated applications. If a user elects to acquire one or more of the updated applications, application program files for the updated application can be electronically delivered to a computing device associated with the user. The availability of updated applications can be presented to users by graphical user interfaces.

The invention can be implemented in numerous ways, including as a method, system, device, apparatus (including computer readable medium and graphical user interface). Several embodiments of the invention are discussed below.

As a computer-implemented method for facilitating updates to application programs, one embodiment of the invention can, for example, include at least: determining availability of an update to an application program of a user, said determining being based in part on prior purchase history of the user; and presenting information to the user about the update that is determined to be available for the application program.

As a computer-implemented method for determining available updates for application programs, one embodiment of the invention can, for example, include at least: identifying application programs previously purchased from an online store by a user based on purchase history data associated with the user; and determining which of the identified application programs has an update available from the online store.

As a computer-implemented method for providing application updates to computing devices, one embodiment of the invention can, for example, include at least: presenting an electronic information page to a requester, the electronic information page including at least an update request control; receiving an update request from the requester via the update request control; determining at least one application update that is available to the requester; and informing the requestor of the at least one application update that is determined to be available to the requester.

As a computer readable medium including at least executable computer program code tangibly stored thereon for determining available updates to application programs, one embodiment of the invention can, for example, include at least: computer program code for identifying application programs previously purchased from an online store by a user based on purchase history data associated with the user; and computer program code for determining which of the identified application programs has an update available from the online store.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a product submission and distribution system according to one embodiment of the invention.

FIG. 2A is a program update process according to one embodiment of the invention.

FIG. 2B is a flow diagram of an application update process according to one embodiment of the invention.

FIG. 3A is a flow diagram of an available updates process according to one embodiment of the invention.

FIG. 3B is a flow diagram of an available updates process according to another embodiment of the invention.

FIG. 4 is a flow diagram of an update process according to one embodiment of the invention.

FIG. 5 is a flow diagram of an available updates determination process according to one embodiment of the invention.

FIG. 6 illustrates an exemplary online store page according to one embodiment of the invention.

FIG. 7A illustrates an exemplary application updates page according to one embodiment of the invention.

FIG. 7B illustrates an exemplary application updates page according to one embodiment of the invention.

FIG. 8A illustrates an exemplary screen illustration of an update availability page according to one embodiment of the invention.

FIG. 8B illustrates an exemplary screen illustration of an update page according to one embodiment of the invention.

FIG. 9 is a flow diagram of an update transaction process according to one embodiment of the invention.

FIG. 10 is a flow diagram of an update transaction process according to another embodiment of the invention.

### DETAILED DESCRIPTION OF THE INVENTION

The invention relates to submission, management and/or distribution of updates to digital products, such as application programs (software programs), with respect to an online product distribution site. Updates to numerous digital products can be centrally managed in a uniform and computer-assisted manner so that updates can be efficiently distributed to appropriate users.

In one embodiment, an online product distribution system can alert users of updated applications that are available to the users. Users can then elect to acquire one, some or all of the updated applications. If a user elects to acquire one or more of the updated applications, application program files for the updated application can be electronically delivered to a computing device associated with the user. The availability of updated applications can be presented to users by graphical user interfaces.

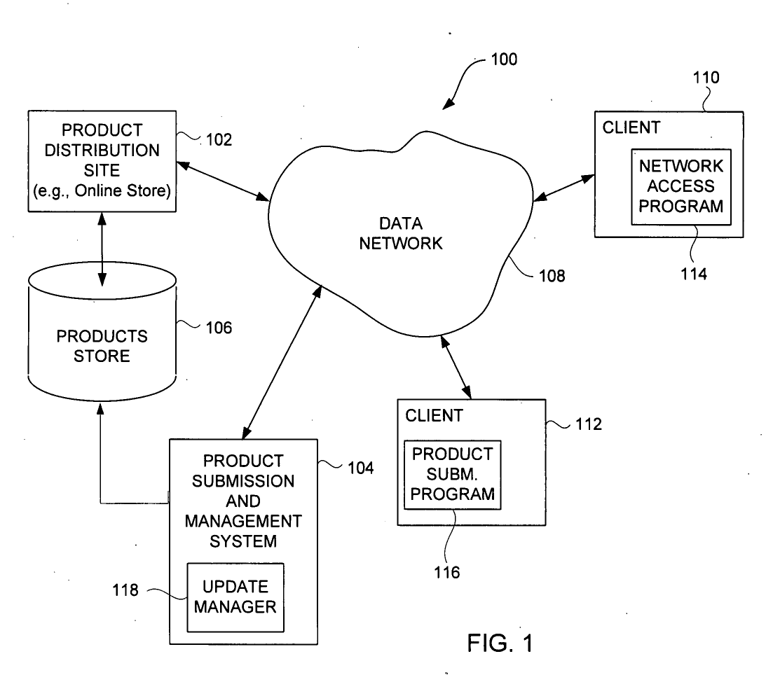

Embodiments of various aspects of the invention are discussed below with reference to FIGS. 1-10. However, those skilled in the art will readily appreciate that the detailed description given herein with respect to these figures is for explanatory purposes as the invention extends beyond these limited embodiments.

FIG. 1 is a block diagram of a product submission and distribution system 100 according to one embodiment of the invention. The product submission and distribution system 100 includes a product distribution site 102. The product distribution site 102 provides an online access point for distribution of various digital products. For example, the product distribution site 102 can also be referred to as an online product hosting site or an online store.

A product submission and management system 104 operates to receive submissions of digital products from various digital product submitters. The product submission and management system 104 can process submission of digital products and authorize distribution of approved digital products. The digital products can be stored in a products store 106. In one embodiment, the products store 106 can include a mass data store and one or more databases. The products store 106 provides mass storage of the numerous digital products that are available for distribution (e.g., purchase or rental). For example, digital products that have been purchased can be accessed from the products store 106 over a data network 108 by way of the product distribution site 102. Also, purchases made by users can be maintained as purchase history data by the product submission and distribution system 100. For example, the purchase history data can be stored in a database or file at any of a variety of locations, such as the product submission and management system 104, the production distribution site 102 or the products store 106. In one embodiment, the digital products are computer program products (e.g., computer software programs). Examples of computer program products are: applications (or application programs), animations, or presentations.

The product submission and distribution system 100 also includes or supports a first client 110 and a second client 112. Typically, the product submission and distribution system 100 would include a plurality of different clients 110, 112. The first client 110 includes a network access program 114. The second client 112 includes a product submission program 116. Some clients can also include both the network access program 114 and the product submission program 116. The network access program 114 is an application program (e.g., software application) that operates on the first client 110, which is a computing device. One example of a suitable network access program is a network browser (e.g., Microsoft Explorer or Safari). Another example of a suitable network access program is iTunes™ offered by Apple Inc. The first client 110 can couple to the product distribution site 102 through the data network 108. Hence, any of the first clients 110 can interact with the product distribution site 102 to review, purchase and/or manage digital products.

The product submission program 116 is also an application program (e.g., software application) that operates on the second client 112, which is a computing device. The product submission program 116 is used to submit digital products to the product submission and management system 104 for eventual distribution by the media distribution site 102. Although the network access program 114 and the product submission program 116 are shown in FIG. 1 as separate programs, it should be understood that such programs can be integrated into a single program or reside on the same client machine.

In the product submission and distribution system 100 shown in FIG. 1, the digital products are submitted to the product submission and management system 104 by way of the product submission program 116. The digital products that have been submitted (e.g., via the second client 112) are processed and then stored in the products store 106. Thereafter, the stored digital products are available to be purchased from the product distribution site 102. Upon purchasing a particular digital product, the product distribution site 102 permits the digital data for the particular digital product to be retrieved from the products store 106 and then delivered (e.g., downloaded) from the product distribution site 102 to the requesting client 110 through the data network 108. In this regard, the product distribution site 102 or some other delivery server (not shown) obtains the digital data corresponding to the particular digital product from the products store 106 and downloads such digital data through the data network 108 to the client 110. The downloaded digital data can then be stored on the client 110. In one embodiment, the downloaded digital data is encrypted as received at the client 110 but is decrypted and then perhaps re-encrypted before persistently stored on the client 110. Thereafter, the client 110 can utilize (e.g., execute) the digital data of the digital product at the client 110.

The product submission and distribution system 100 allows a user of the client 110 to utilize the network access program 114 to browse, search or sort through a plurality of digital products that can be purchased from the product distribution site 102. The network access program 114 may also allow the user to preview or demo some or all of a digital product. In the event that the user of the network access program 114 desires to purchase a particular digital product, the user (via the network access program 114) and the product distribution site 102 can engage in an online commerce transaction in which the user pays for access rights to the particular digital product. In one embodiment, a credit card associated with the user is credited for a purchase (or rental amount) of the particular digital product.

After a user has purchased a digital product, the digital product might be updated. The updates to the digital product can pertain to “fixes” of minor errors or inclusion of additional features. The updated digital product is considered a new release of the digital product. In general, when the digital products are software programs (or application programs), if the new version is a minor improvement to the prior version, the new version of the software program can be considered an update. Alternatively, if the new version is a major improvement, the new version of the software program can be considered an upgrade. Regardless, an upgrade can also be considered an update.

To support updates, the product submission and management system 104 can permit product developers (e.g., software developers) to submit updated application programs for distribution by the product distribution site 102. Here, a product developer can submit a new application program file. In this case, an updated application program can be provided with an indication of its version number and/or with release notes. Once approved for distribution, the updated application program will replace the previous application program on the product distribution site 102 such that the updated application program is thereafter the application program to be distributed to purchasers.

Further, once an updated application program is received, an update manager 118 can operate to alert users of availability of updated application programs. In doing so, the update manager 118 can access purchase history data of users to determine those users that could benefit from any of the updated application programs. Users can then be informed or altered to the availability of updated application. In one embodiment, users seeking the updated application can be directed to a particular network location (e.g., within the product distribution site), such as via a link (e.g., hyperlink), so that the updated application can be acquired. In one implementation, the acquisition of updated application can be made available to user having previously purchased an earlier version for reduced or no cost.

The submission and purchase of the digital products can be achieved over the data network 108. In other words, the submission and purchase of the digital products can be achieved online. The purchase of media items online can also be referred to as electronic commerce (e-commerce). In one embodiment, the data network 108 can make use of at least a portion of the Internet. The clients 110, 112 can vary with application but generally are computing devices that have memory storage. Often, the clients 110, 112 are personal computers or other computing devices that are capable of storing and presenting media to their users. In one embodiment, the connections through the data network 108 between the product distribution site 102 and the clients 110, 112 can be through secure connections, such as Secure Sockets Layer (SSL).

Although the product distribution site 102, the product submission and management system 104 and the products store 106 are shown in FIG. 1 as being separate components, it should be understood that any of these components can be combined into one or more apparatus. For example, the product submission and management system 104 can be incorporated into the product distribution site 102. As another example, the products store 106 can be incorporated into the product distribution site 102 or the product submission and management system 104. Also, for improved efficiency, certain data, such as purchase history data, can be maintained in a more efficiently accessible data structure (e.g., cache).

Those of the updated applications that are available can be restricted (or filtered) to only those available for use on certain computing devices. For example, some applications are design to operate only on a particular type of computing platform (e.g., handheld device) and not on a desktop computer. As another example, the updated application being indicated as available might only be suitable for use on certain devices. Hence, the availability can be restricted to only those application programs that can operate on the device being utilized by the user or associated with the user. The availability of updated applications can also be limited to those devices that have the earlier version of the application program.

Additional details on the product submission and management system 104 can be found in U.S. Provisional Patent Application No. 61/050,478, filed May 5, 2008, entitled “ELECTRONIC SUBMISSION AND MANAGEMENT OF DIGITAL PRODUCTS FOR NETWORK-BASED DISTRIBUTION”, which is hereby incorporated herein by reference.

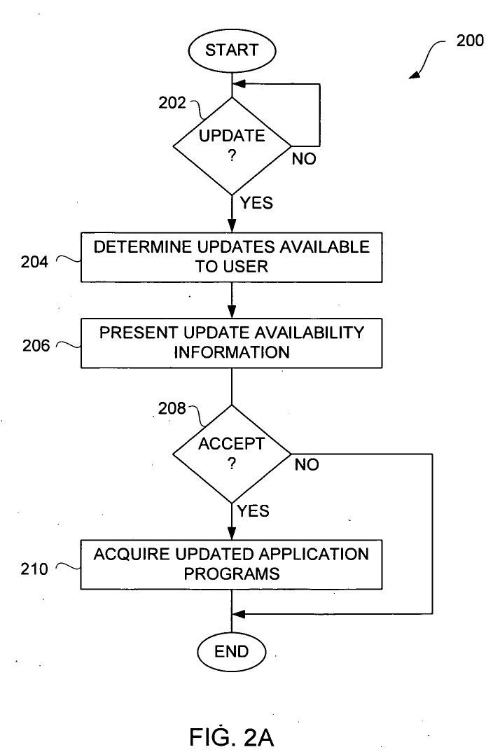

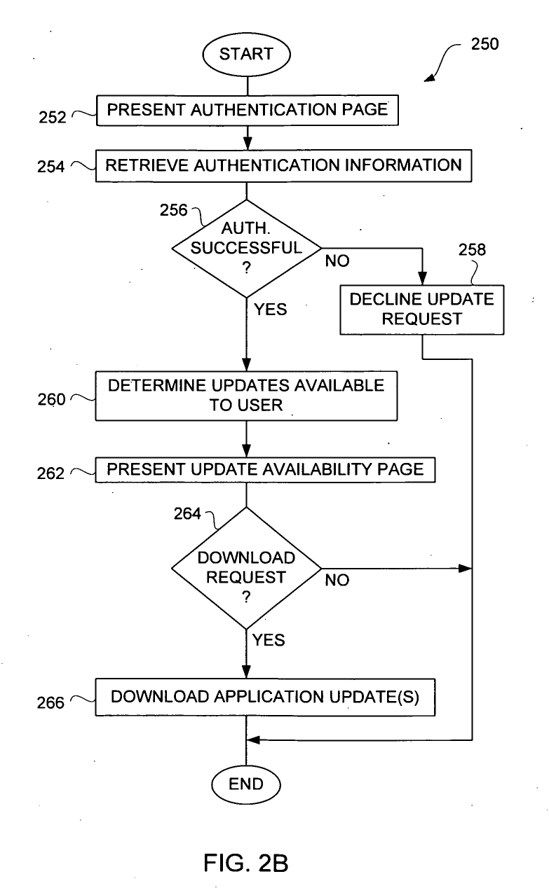

FIG. 2A is a program update process 200 according to one embodiment of the invention. The program update process 200 can, for example, be performed by a client-side application or a server-side application. As an example, the client-side application can be the network access program 114. As another example, the server-side application can be the product submission and management system 104 (such as the update manager 118 or the product distribution site 102).

The program update process 200 can begin with a decision 202 that determines whether an update is to be processed. As an example, an update can be initiated at the request of a user of a client device or a client-side application operating on the client device, or at the initiation of a client device or server itself. When the decision 202 determines that an update should be processed, the program update process 200 can continue. In other words, when the decision 202 determines that an update should be processed, the program update process 200 can be effectively invoked.

Once the decision 202 determines that an update should be processed, those one or more updates that are available can be determined 204. Here, the updates that are determined 204 can be those updates that are available to the user. For example, the user typically has an earlier version of one or more application programs (on a computing device) that are available to be updated. Next, update availability information can be presented 206. Typically, the update availability information is information that indicates to the user those one or more updates for application programs that are available to the user. In one embodiment, the update availability information can be presented to the user by being displayed on a display screen of a computing device associated with the user.

Next, a decision 208 can determine whether the user has accepted one or more of the available updates. When the user has selected one or more of the available updates, the program update process 200 can acquire 210 one or more updated application programs corresponding to the selected one or more of the available updates. Alternatively, when the decision 208 determines that the user has not accepted any of the one or more available updates, the block 210 can be bypassed. Following the block 210, or its being bypassed, the program update process 200 can end.

FIG. 2B is a flow diagram of an application update process 250 according to one embodiment of the invention. The application update process 250 can, for example, be performed by a client-side application or a server-side application. As an example, the client-side application can be the network access program 114. As another example, the server-side application can be the product submission and management system 104 (such as the update manager 118 or the product distribution site 102). The application update process 250 is generally similar to the program update process 200 illustrated in FIG. 2A but further requires user authentication.

The application update process 250 can present 252 an authentication page. In response to the authentication page, a user that is requesting to update one or more of its previously purchased application programs can provide authentication information. Hence, authentication information is then received 254. A decision 256 can then determine whether the user has been successfully authenticated using the authentication information. When the decision 256 determines that the user has not been successfully authenticated, the update request can be declined 258. In this case, the application update process 250 ends without having performed any application updates.

On the other hand, when the decision 256 determines that the user has been successfully authenticated, the application update process 250 can determine 260 those updates that are available to the user. An update availability page can then be presented 262 to the user. The update availability page can inform the user of the one or more updates to its previously purchased application programs that are now available to the user. These updates may be provided free of charge or may require payment of a fee.

Next, a decision 264 can determine whether a download request has been received. In one embodiment, from the update availability page, the user can elect to proceed to download the one or more available updates or can decline to download any of the available updates. Of course, if there are no updates available to the user, the decision 264 can effectively likewise determine that download is not to be performed. In the case where the decision 264 determines that a download request has been received, the one or more available application updates are downloaded 266 for the benefit of the user. Typically, the one or more application updates are downloaded 266 to a client machine, such as a personal computer, that is accessing the online store via a network connection. In cases where the application updates are not for previous applications on the personal computer, but instead for another device that couples to the personal computer on occasion, then the application updates are eventually delivered and installed on the another device. The another device might a portable computing device, such as a handheld computing device, a mobile telephone or a personal digital assistant, that subsequently couples to the personal computer. In such case, when the portable computing device couples to the client machine, the application updates can be provided to the portable computing device that has the corresponding previous applications installed thereon. A synchronization operation between the client machine and the portable computing device can be used to transfer the application updates from the client machine to the portable computing device. Thereafter, following any downloading 266, the application update process 250 can end.

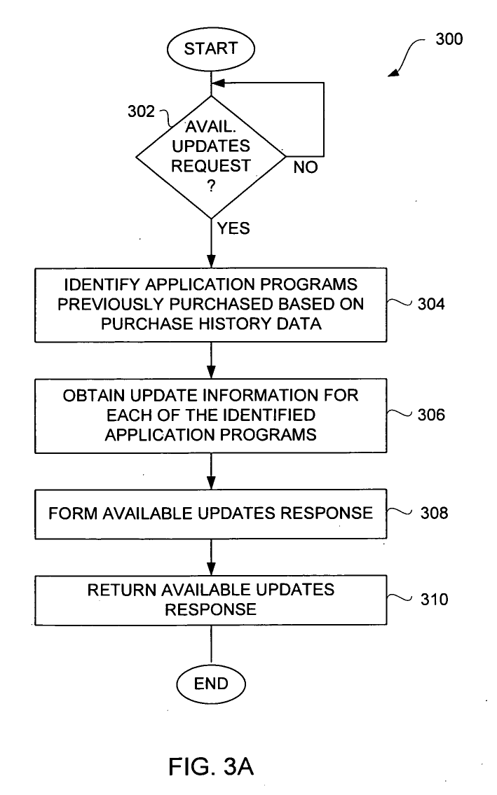

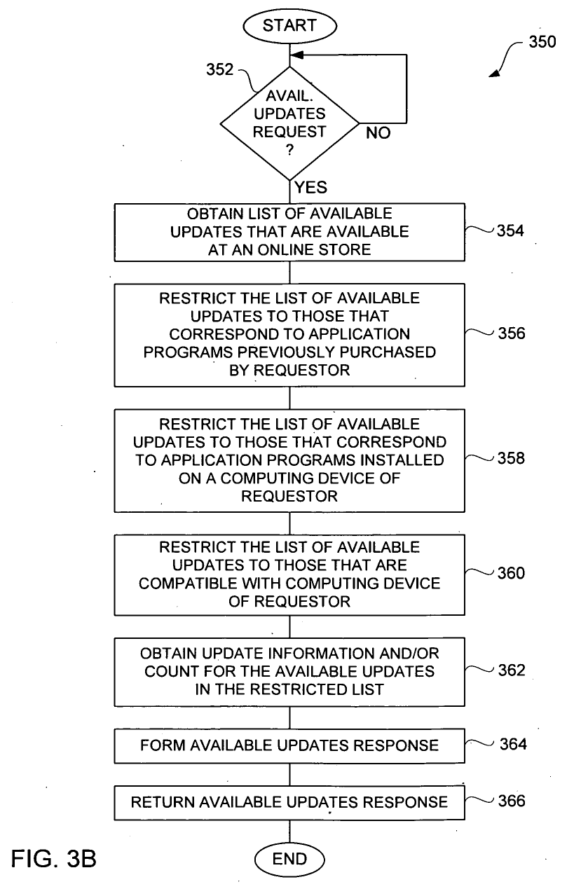

FIG. 3A is a flow diagram of an available updates process 300 according to one embodiment of the invention. The available updates process 300 can, for example, be performed by server-side processing, such as processing performed by the update manager 118 or the product distribution site 102 illustrated in FIG. 1, operating on a server device. In doing so, the server-side application can interact with a client-side application, such as the network access program 114.

The available updates process 300 can begin with a decision 302. The decision 302 can determine whether an available updates request has been received. Here, the available updates process 300 can be initialed once an available updates request has been received from a requester. For example, a user can interact with the network access program 114 to cause an available updates request to be sent and then received by the update manager 118. When the decision 302 determines that an available updates request has not been received, the available updates process 300 can await such a request.

On the other hand, once the decision 302 determines that an available updates request has been received, those one or more application programs previously purchased can be identified 304 based on purchase history data. For example, a product distribution site, such as the product distribution site 102 can be utilized by a user to purchase application programs. In doing so, the product distribution site 102 (and/or its supporting product submission and management system 104 or products store 106) can maintain a purchase history data for users. Hence, the one or more application programs that have been previously purchased by a particular user can be identified 304 using the purchase history data for the user. Update information can be obtained 306 for each of the identified application programs. The update information is information that is descriptive of available updates or information (or data) that supports the acquisition of available updates. An available updates response can then be formed at 308. In one embodiment, the available updates response can include the update information for each of the identified application programs. Thereafter, the available updates response can be returned 310 to the requester.

FIG. 3B is a flow diagram of an available updates process 350 according to another embodiment of the invention. The available updates process 300 can, for example, be performed by server-side processing, such as processing performed by the update manager 118 or the product distribution site 102 illustrated in FIG. 1, operating on a server device. In doing so, the server-side application can interact with a client-side application, such as the network access program 114.

The available updates process 350 can begin with a decision 352. The decision 352 can determine whether an available updates request has been received. Here, the available updates process 350 can be deemed to be invoked once an available updates request has been received from a requester. For example, a user can interact with the network access program 114 to cause an available updates request to be sent and then received by the update manager 118. When the decision 352 determines that an available updates request has not been received, the available updates process 350 can await such a request.

On the other hand, once the decision 352 determines that an available updates request has been received, a list of available updates that are available at an online store can be obtained. The list of available updates may include updates that are not suitable for the requestor. Typically, the available updates are those updates that are generally available from the online store. The list of available updates can be been restricted 356 to those updates that correspond to application programs previously purchased by the requestor. In one embodiment, the server can store a purchase history for the requester and use the purchase history to restrict the list of available updates to those updates that correspond to application programs previously purchased by the requester.

In addition, the list of available updates can be restricted to 358 to those available updates that correspond to application programs installed on a computing device of the requester. The computing device can be the computing device currently being utilized by the requestor or it can pertain to another computing device that has been previously associated with the requestor. In one embodiment, the computing device can inform the server of the application programs that are installed on the computing device.

Further, the list of available updates can be restricted 360 to those available updates that are compatible with the computing device of the requester. Some application programs as well as some updates can be designed for use on limited computing platforms. For example, if an update is for an application program is suitable for use only on a first type of platform (e.g., mobile communications handheld), the application program could be restricted 360 when the computing device of the requester a second type of platform (e.g., portable media player) which is different than the first type of platform.

Next, update information and/or a count for the available updates in the restricted list can be obtained 362. Thereafter, an available updates response can be formed 364. The available updates response can then be returned 366 to the requester. Once returned to the requester, the available updates response can be presented (e.g., displayed) for the requester. Following the block 366, the available updates process 350 can end.

Accordingly, the available updates process 350 permits a server device to process a general list of available updates to restrict the list to those available updates that are usable by the requester on the computing device of the requester. As noted in FIG. 3B, the restrictions can pertain to prior purchases, device compatibility, and/or present installation. These restrictions can also be referred to as filtering.

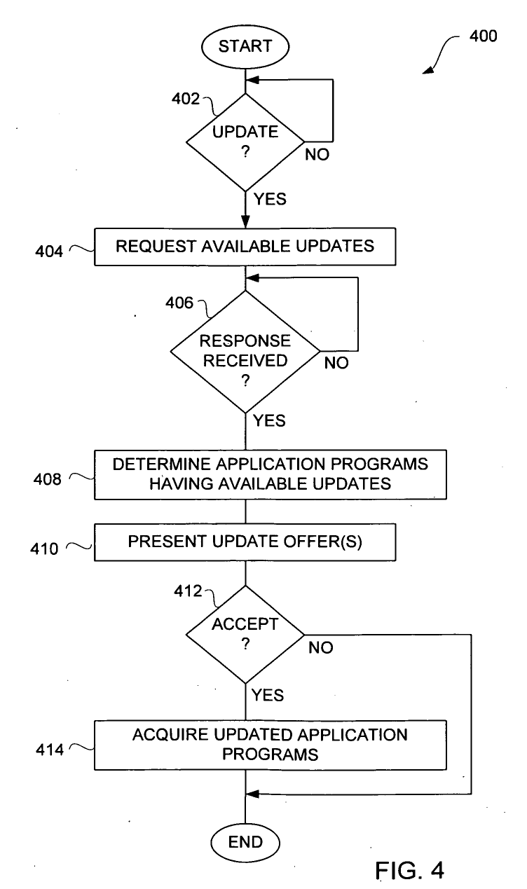

FIG. 4 is a flow diagram of an update process 400 according to one embodiment of the invention. The update process 400 is, for example, processing that can be performed at a client-side application, such as an application program operating on a client machine. In one implementation, the update process 400 can be performed by the network access program 114 operating on the client 110 illustrated in FIG. 1.

The update process 400 can begin with a decision 402 that determines whether an update is to be performed. When the decision 402 determines that an update is not yet needed, the update process 400 can await a need to perform the update process 400. As an example, an update could be requested by a user interaction or could be initiated by device operation. In any case, once the decision 402 determines that an update is to be performed, available updates are requested 404. Here, the available updates are requested 404 from a remote server. In one implementation, the remote server can pertain to the product submission and management system 104 and/or the update manager 118 of the product submission and distribution system 100 illustrated in FIG. 1.

Next, a decision 406 determines whether a response has been received to the available updates request. When the decision 406 determines that a response has not yet been received, the update process 400 can await such a response. Once the decision 406 determines that a response has been received, application programs having available updates can be determined 408. Here, the response to the available updates request 404 includes information that can be evaluated by the update process 400 to determine 408 one or more application programs that have available updates.

After the application programs having available updates have been determined 408, one or more update offers can be presented 402. For example, one or more update offers can be presented to a user of the client machine by display of update information pertaining to such update offers. As an example, the update offer can indicate one or more of: software developer, title, version, size and platform for the updated application program. The update offer can also typically include a cost (price) for the update or an indication that the update is without charge.

A decision 412 can then determine whether the user has accepted any of the one or more update offers being presented 410. In one embodiment, the user can accept one, some or all of the update offers being presented 410. In any case, when the decision 412 determines that the user has accepted at least one of the update offers, the one or more updated application programs corresponding to the one or more accepted update offers can be acquired 414. Alternatively, when the decision 412 determines that the user has not accepted any of the one or more update offers, the block 414 can be bypassed. Following the block 414, or its being bypassed, the updates process 400 can end.

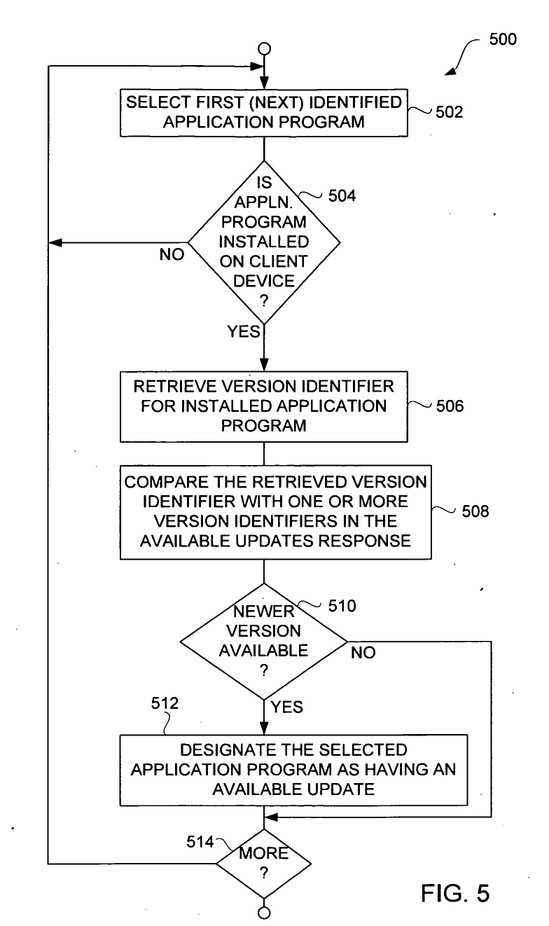

FIG. 5 is a flow diagram of an available updates determination process 500 according to one embodiment of the invention. The available updates determination process 500 is, for example, processing performed by block 408 of the updates process 400 illustrated in FIG. 4.

The available updates determination process 500 selects 502 a first identified application program. The identified application programs are provided, for example, in the response to the available updates request at block 404 of the updates process 400. After the selection 502 of the identified application program, a decision 504 can determine whether the selected application program (i.e., earlier version) is installed on the client device. When the decision 504 determines that the selected application program is installed on the client device, a version identifier for the installed application program can be retrieved 506. Here, the installed application program as a version identifier associated therewith and stored on the client device. Hence, the retrieval 506 of the version identifier can retrieve the version identifier stored at the client device.

Next, the retrieved version identifier can be compared 508 with one or more version identifiers in the available updates response. In doing so, the available updates determination process 500 is able to evaluate whether the selected identified application program having an available update is suitable for updating the installed application program on the client device. In one implementation, the version identifiers in the available updates response can indicate at least the current version of the application program of interest. In another implementation, the version identifiers in the available updates response can include a series of version identifiers with the largest numerical version number being the current version of the application program of interest.

Following the comparison 508, a decision 510 can determine whether a newer version is available for the client device. When the decision 510 determines that there is a newer version available, the selected application program can be designated 512 as having an available update. In this case, the selected application program being processed by the available updates determination process 500 is determined to be suitable for use in updating the corresponding installed application program at the client device. Alternatively, when the decision 510 determines that a newer version is not available, the block 512 can be bypassed so that the selected application program is not denoted as having an available update suitable for the client device. In one embodiment, since developer versioning tends to be inconsistent and not reliable, the system can assign internal version numbers that are used to manage updates.

Following the block 512, or its being bypassed, a decision 514 can determine whether there are more identified application programs to be processed. When the decision 514 determines that there are more identified application programs to be processed, the available updates determination process 500 can return to repeat the block 502 where a next identified application program can be selected. Thereafter, the processing of the then selected identified application program can proceed as discussed above. Alternatively, once the decision 514 determines that there are no more identified application programs to be processed, the available updates determination process 500 can end.

The availability of updated application can be presented to users by graphical user interfaces. In one embodiment, the application programs available for update can present (e.g., display) graphical and/or textual indicia for each of one or more of the application programs available for update. The graphical user interface can also include an individual acquisition button for each of the application programs available for update that are displayed. Still further, alternatively or additionally, the graphical user interface can also include a group acquisition button that, upon selection, operates to initiate acquisition of the application programs that are available for update by the user.

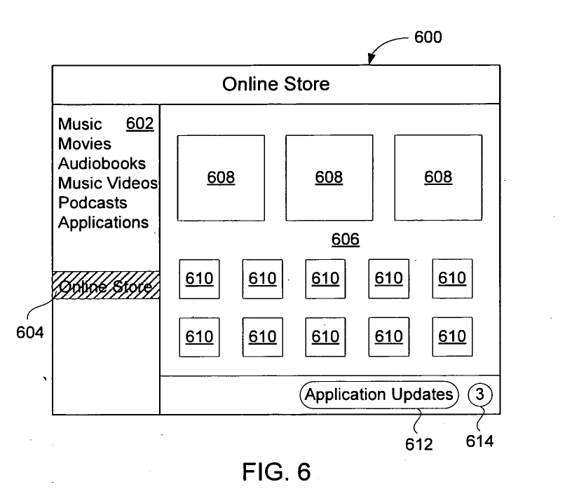

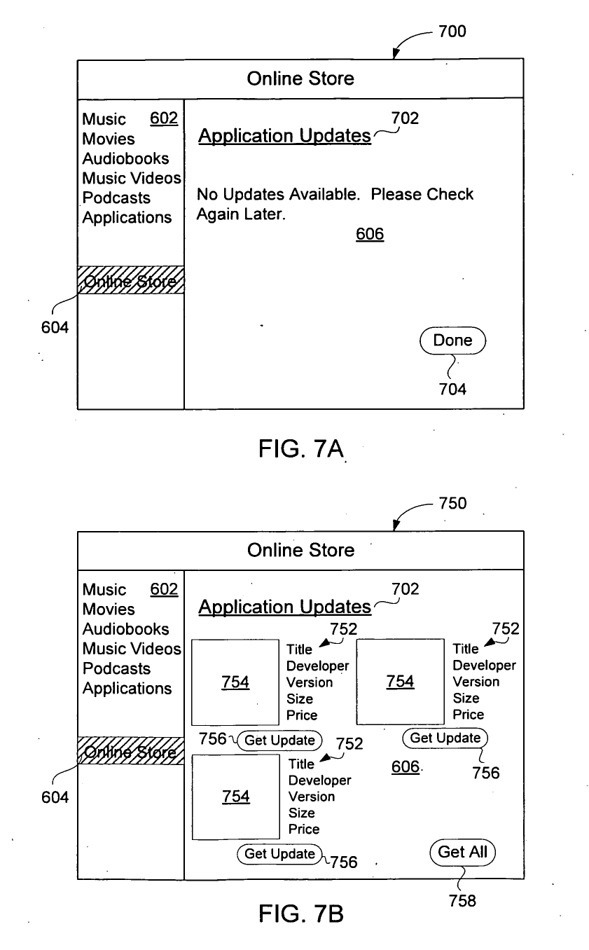

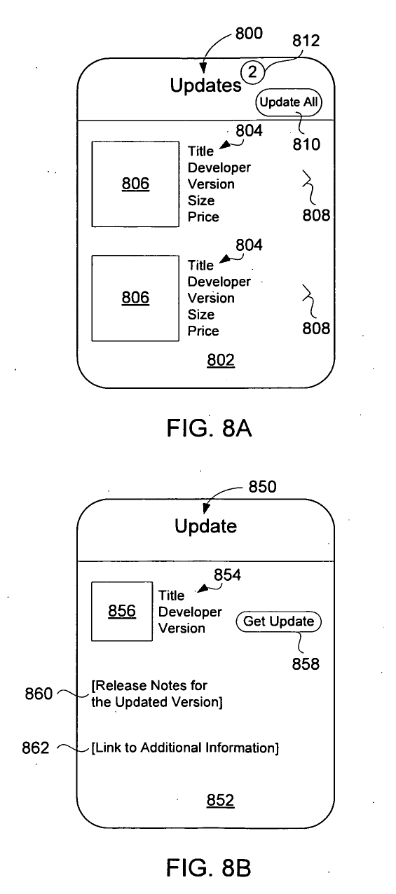

The update of application programs can be performed by a variety of different computing devices. FIGS. 6, 7A and 7B illustrate representative screens that can be provided on a display screen of a portable or desktop computer. FIGS. 8A and 8B illustrate representative screens that can be provided on a smaller display screen of a handheld computing device (e.g., mobile telephone, PDA, etc.).

FIG. 6 illustrates an exemplary online store page 600 according to one embodiment of the invention. The exemplary online store page 600 presents information pertaining to digital products that are available for distribution from the online store. The online store page 600 includes a source region 602 where a user can specify a source or type of digital product of interest. For example, examples of different types of digital products include music, movies, audio books, music videos, podcasts and applications. In addition, the source region 602 allows the user to specify a source of content, namely, either the online store or locally stored content, such as the above-noted different types of digital products. As illustrated in FIG. 6, the online store is shown as being selected 604, such that a digital products region 606 displays a plurality of digital products that are available for distribution from the online store. In one embodiment, the digital products can be any of the various different types of digital products. However, in this embodiment, it is assumed that the digital products 608 and 610 being depicted in the digital products region 606 are application programs. The digital products 608 are presented in an enhanced fashion as compared to the presentation of the digital products 610. Additionally, the online store page 600 can also display an application updates control 612. For example, the application updates control 612 can present a virtual button. Upon selection of the application updates control 612, the user can transition to one or more other pages that assist the user with updating applications (e.g., see FIGS. 7A and 7B). The online store page 600 can also display an indicator 614 of the number of application updates that are available to the user. As illustrated in FIG. 6, the indicator 614 displays the numeric “3” indicating that there are three application updates that are available to the user. The processing discussed above can be used to dynamically determine the number of updates that are available to the user.

FIG. 7A illustrates an exemplary application updates page 700 according to one embodiment of the invention. The applications updates page 700 can be displayed upon selection of the application updates control 612 of the online store page 600 illustrated in FIG. 6. The application updates page 700 is a page pertaining to application updates that can be provided by the online store. The application updates page 700 provides an application updates indication 702 in the digital products region 606. In this example, there are no application updates available to the user at this time. Hence, the digital products region 606 can display a message indicating the same to the user. When the user is done with these application updates page 700, a user interface control 704 (“Done” button) can be selected to close the application updates page 700.

FIG. 7B illustrates an exemplary application updates page 750 according to one embodiment of the invention. The applications updates page 750 can be displayed upon selection of the application updates control 612 of the online store page 600 illustrated in FIG. 6. The application updates page 750 is a page pertaining to application updates that can be provided by the online store. The application updates page 700 provides an application updates indication 702 in the digital products region 606. In one implementation, the online store can determine whether any application updates are available based on prior purchases with the online store. The applications updates page 750 can include a user interface that allows a user to initiate download of some or all of the available application updates. In this example, there are three (3) applications updates available to the user at this time. Hence, the digital products region 606 can display information on each of the available application updates. For example, for each of the available application updates, the digital products region 606 can display descriptive information 752, a graphical image 754 and an update control 756. The descriptive information 752 can, for example, specify title, developer name, version, size and price for the available application update. In some cases, the price can be denoted as “free” (no charge). The graphical image 754 can be an image that corresponds to the application program or the developer for the application program. The update control 756 can pertain to a virtual button (“Get Update”) that upon selection initiates acquisition of the corresponding application update. The digital products region 606 can also include another update control 758. The update control 758 can pertain to a virtual button (“Get All”) that upon selection by a user can initiate acquisition of all of the available application updates or the user.

FIG. 8A illustrates an exemplary screen illustration of an update availability page 800 according to one embodiment of the invention. The update availability page 800 includes an information window 802. Within the information window 802, information on one or more available application updates can be presented. Namely, in the example illustrated in FIG. 8A, there are two available application updates for the user. For example, for each of the available application updates, the information window 802 can display descriptive information 804, a graphical image 806 and a select control 808. The descriptive information 804 can, for example, specify title, developer name, version, size and price for the available application update. The graphical image 806 can be an image that corresponds to the application program or the developer for the application program. The select control 808 can be used to transition to a detailed information page pertaining to the corresponding application program update (see FIG. 8B). The update availability page 800 can also display an update control 810 that can pertain to a virtual button (“Update All”) that upon selection by a user can initiate acquisition of all of the available application updates for the user. Still further, the update availability page 800 can display an indicator 812 of the number of application updates that are available to the user. As illustrated in FIG. 8, the indicator 812 displays the numeric “2” indicating that there are two application updates that are available to the user.

FIG. 8B illustrates an exemplary screen illustration of an update page 850 according to one embodiment of the invention. The update page 850 pertains to a particular available application update. The update page 850 can be displayed upon selection of the select control 808 of the update availability page 800 illustrated in FIG. 8A. The update page 850 is a page pertaining to an application update that can be provided by the online store. The update page 850 includes an information window 852. Within the information window 852, information on an available application update can be presented. The information window 852 can display descriptive information 854, a graphical image 856 and an update control 858. The descriptive information 854 can, for example, specify title, developer name and version for the available application update. The graphical image 856 can be an image that corresponds to the application program or the developer for the application program. The update control 858 can pertain to a virtual button (“Get Update”) and that upon selection initiates acquisition of the corresponding application update. The information window 852 can further include release notes 860 and a link 862 to additional information. The release notes 860 can explain the changes made to the updates to the application program. The link 862 can direct the user to a website where additional information about the updated program can be acquired.

As previously noted, one or more updates to applications can be acquired. Once the list of available updates is known, an update transaction can be performed to acquire one or more available updates.

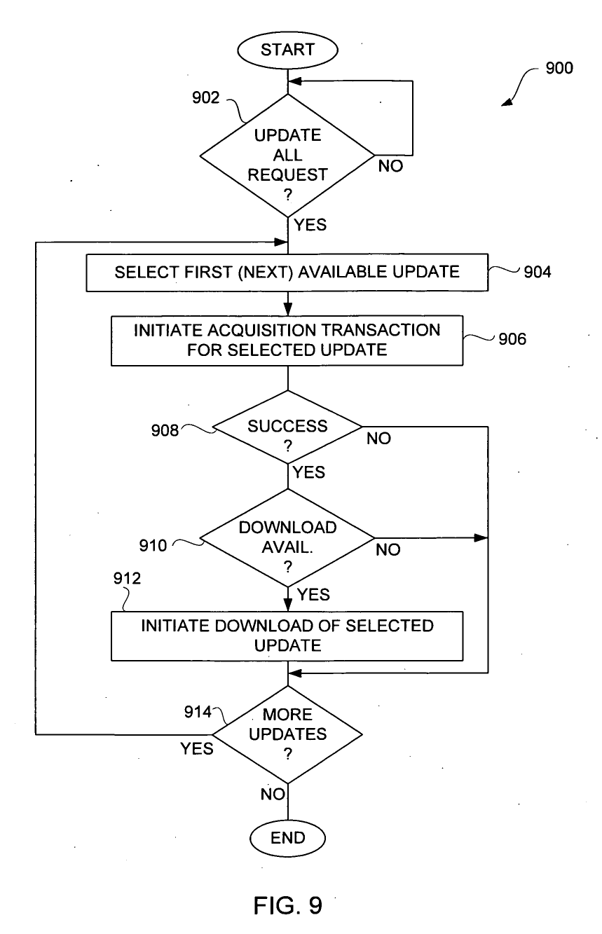

FIG. 9 is a flow diagram of an update transaction process 900 according to one embodiment of the invention. The update transaction process 900 can be performed by a client-side application, such as an application program operating on a client machine. In one implementation, the update transaction process 900 can be performed by the network access program 114 operating on the client 110 illustrated in FIG. 1.

The update transaction process 900 can begin with a decision 902. The decision 902 can determine whether an update all request has been received. An update all request is a request for all updates available to a requester. When the decision 902 determines an update all request has not been received, the update transaction process 900 can await such a request.

Once the decision 902 determines that an update all request has been received, a first available update can be selected 904 as a selected update for processing. Next, an acquisition transaction can be initiated 906 for the selected update. Here, the acquisition transaction can be performed on a remote server device to cause the acquisition of the selected update. For example, the acquisition transaction can be a purchase, lease or rent for a charge or for no cost.

A decision 908 can determine whether the acquisition transition has been successful. When the decision 908 determines that the acquisition transaction was successful, a decision 910 can determine availability of a download of the selected update. When the decision 910 determines that the download for the selected update is available, download of the selected update can be initiated 912. On the other hand, when the decision 908 determines that the acquisition transaction was unsuccessful or when the decision 910 determines that download for the selected update is unavailable, the initiation 912 of the download can be bypassed.

Following the block 912, or its being bypassed, a decision 914 can determine whether there are more updates to be processed. Typically, the update all request involves an acquisition of a plurality of different updates for different application programs. Hence, the decision 914 determines whether all of the updates to be obtained have been processed. When the decision 914 determines that there are more updates to be processed, the update transaction process 900 can return to repeat the block 904 so that a next available update can be selected and similarly processed. Once the decision 914 determines that there are no more updates to be processed, the update transaction process 900 can end.

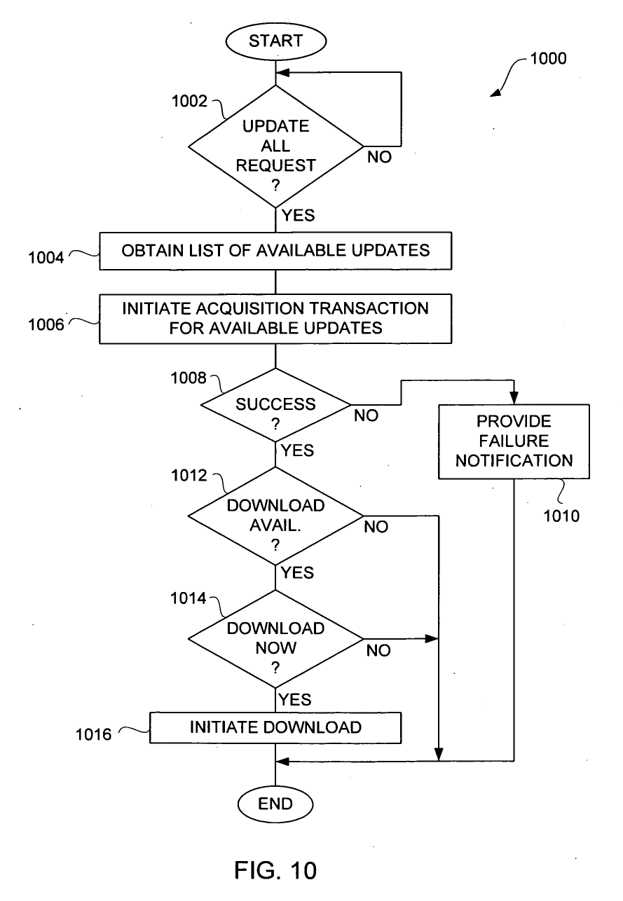

FIG. 10 is a flow diagram of an update transaction process 1000 according to one embodiment of the invention. The update transaction process 1000 can be performed by a client-side application, such as an application program operating on a client machine. In one implementation, the update transaction process 1000 can be performed by the network access program 114 operating on the client 110 illustrated in FIG. 1.

The update transaction process 1000 can begin with a decision 1002 that determines whether an update all request has been received. When the decision 1002 determines that an update all request has not been received, the update transaction process 1000 can await such a request. Once the decision 1002 determines that an update all request has been received, a list of available updates can be obtained 1004. In one embodiment, the list of available updates is a list of updates that are available to a particular user. For example, the list of available updates can utilize processing discussed above to limit, restrict or otherwise filter those updates that are to be available to particular users. After the list of available updates has been obtained 1004, an acquisition transaction can be initiated 1006 for the available updates. In one embodiment, a separate server is responsible for performing acquisition transactions to satisfy any financial or other transaction requirements.

Next, a decision 1008 determines whether the acquisition transition has been successful. When the decision 1008 determines that the acquisition transaction has not been successful, a failure notification can be provided 1010. On the other hand, when the decision 1008 determines that the acquisition transition has been successful, a decision 1012 can determine whether download of the available updates is available. When the decision 1012 determines that download for the available updates is available, a decision 1014 can determine whether the available updates within an appropriate download queue are to be downloaded at this time. The decision 1014 can be automatically determined by the server, by the user or by a client application being utilized by the user. When the decision 1014 determines that the available updates are to be downloaded at this time, download of the available updates from the appropriate queue can be initiated 1016. In one embodiment, download of the available updates from the appropriate download queue can be initiated 1016. In one embodiment, the download queue is particular to the user. In another embodiment, the appropriate download queue is one of a plurality of download queues that are particular to the user and segregated based on type of device being utilized by the user.

On the other hand, when the decision 1012 determines that download of the available updates is unavailable or when the decision 1014 determines that the available updates are not to be downloaded at this time, the block 1016 can be bypassed so that download of available updates does not occur. Following the block 1010, the block 1016, or the bypassing of the block 1016, the update transaction process 1000 can end.

An online distribution system for digital products, namely computer program products, can receive electronic submission of not only computer program products (including updates) but also product information, developer information and distribution parameters. The online distribution system can then present the computer program products for distribution at an online distribution site in accordance with the distribution parameters. The online distribution site also can present potential purchases with product information and/or developer information prior to any purchase. Product information and/or developer information can be used to generate windows (or webpages) for presentation of such information. These windows can be automatically generated from the electronic submission of the product information and/or the developer information. Further, these windows can have a consistent pattern that facilitates usage by users that often search and browse through many different available computer program products. Additional details on online product distribution can be found in U.S. Provisional Patent Application No. 61/059,790, filed Jun. 8, 2008, entitled “NETWORK-BASED DISTRIBUTION OF APPLICATION PRODUCTS”, which is hereby incorporated herein by reference.

This application also references and/or incorporates: (1) U.S. patent application Ser. No. 10/687,534, filed Oct. 15, 2003, and entitled “METHOD AND SYSTEM FOR SUBMITTING MEDIA FOR NETWORK-BASED PURCHASE AND DISTRIBUTION”, which is hereby incorporated herein by reference; (2) U.S. patent application Ser. No. 11/712,303, filed Feb. 27, 2007, and entitled “PROCESSING OF METADATA CONTENT AND MEDIA CONTENT RECEIVED BY A MEDIA DISTRIBUTION SYSTEM”, which is hereby incorporated herein by reference; (3) U.S. patent application Ser. No. 11/609,815, filed Dec. 12, 2006, and entitled “TECHNIQUES AND SYSTEMS FOR ELECTRONIC SUBMISSION OF MEDIA FOR NETWORK-BASED DISTRIBUTION”, which is hereby incorporated herein by reference; (4) U.S. patent application Ser. No. 11/622,923, filed Jan. 12, 2007, and entitled “COMPUTERIZED MANAGEMENT OF MEDIA DISTRIBUTION AGREEMENTS”, which is hereby incorporated herein by reference; and (5) U.S. Provisional Patent Application No. 61/050,478, filed May 5, 2008, entitled “ELECTRONIC SUBMISSION AND MANAGEMENT OF DIGITAL PRODUCTS FOR NETWORK-BASED DISTRIBUTION”, which is hereby incorporated herein by reference.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of certain embodiments of the invention is that online distribution sites can manage and distribute updates to previously purchased digital products, such as for updated application programs (updated computer software). Another advantage of certain embodiments of the invention is that distribution of updates to digital products can be achieve in a centralized manner. Another advantage of certain embodiments of the invention is that graphical user interfaces that can inform users of available updates to digital products and/or can facilitate users in requesting updates. Still another advantage of certain embodiments of the invention is that updated digital products can be electronically submitted by users and then be made automatically available to appropriate prior purchasers.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for facilitating updates to application programs, said method comprising:
determining availability of an update to an application program of a user, said determining being based in part on prior purchase history of the user; and
presenting information to the user about the update that is determined to be available for the application program.

2. A method as recited in claim 1, wherein said method comprises:
receiving, prior to said determining, a user request to acquire the update to the application program; and
acquiring, following said determining, an updated version of the application program.

3. A method as recited in claim 2, wherein said acquiring comprises:
downloading the updated version of the application program to a first computing device associated with the user; and
subsequently copying the updated version of the application program to a second computing device associated with the user.

4. A method as recited in claim 3, wherein said acquiring further comprises:
installing the updated version of the application program on the second computing device.

5. A method as recited in claim 2,
wherein the prior purchase history is purchase history with respect to an online store, and
wherein said acquiring acquires the updated version of the application program via the online store.

6. A computer-implemented method for determining available updates for application programs, said method comprising:
identifying application programs previously purchased from an online store by a user based on purchase history data associated with the user; and
determining which of the identified application programs has an update available from the online store.

7. A method as recited in claim 6, wherein said method further comprises:
presenting to the user update information on those of the identified application programs that have an update available from the online store.

8. A method as recited in claim 7, wherein said method further comprises:
receiving a user indication to acquire one or more of the identified application programs that have an update available from the online store.

9. A method as recited in claim 8, wherein said method further comprises:
delivering an update application program file to a computing device of the user following said receiving of the user indication.

10. A computer-implemented method for providing application updates to computing devices, said computer-implemented method comprising:
presenting an electronic information page to a requester, the electronic information page including at least an update request control;
receiving an update request from the requester via the update request control;
determining at least one application update that is available to the requester; and
informing the requester of the at least one application update that is determined to be available to the requester.

11. A computer-implemented method as recited in claim 10, wherein said determining determines the at least one application update that is available to the requestor based on a prior purchase history of the requester.

12. A computer-implemented method as recited in claim 11, wherein said method further comprises:
authenticating the requester of the update request.

13. A computer-implemented method as recited in claim 12, wherein said method further comprises:
informing the requestor that no application updates are available if said authenticating is unsuccessful.

14. A computer-implemented method as recited in claim 10, wherein an application update is available only to those requesters that previously purchased an earlier version of the application program that is being updated.

15. A computer-implemented method as recited in claim 10, wherein the electronic information page is provided by accessing an online store having a plurality of application programs available for distribution.

16. A computer-implemented method as recited in claim 15, wherein the electronic information page further displays an indicator of a number of application updates that are available to the user.

17. A computer-implemented method as recited in claim 15, wherein an application update is available only to those requesters that previously purchased from the online store an earlier version of the application program that is being updated.

18. A computer-implemented method as recited in claim 17, wherein said determining determines the at least one application update that is available to the requester based on a prior purchase history of the requester with the online store.

19. A computer readable medium including at least executable computer program code tangibly stored thereon for determining available updates to application programs, said computer readable medium comprising:
computer program code for identifying application programs previously purchased from an online store by a user based on purchase history data associated with the user; and
computer program code for determining which of the identified application programs has an update available from the online store.
